(19) United States
(12) Patent Application Publication
(10) Pub. No.: US 2014/0021217 A1
(43) Pub. Date: Jan. 23, 2014

(54) VENDING MACHINE WITH PRODUCT RECEIVING STRUCTURE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: Yun-Lung CHEN, New Taipei (TW); Chin-Wen YEH, New Taipei (TW); Yang XIAO, Wuhan (CN); Dun-Jun ZHOU, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 13/868,345

(22) Filed: Apr. 23, 2013

(30) Foreign Application Priority Data
Jul. 17, 2012 (CN) 2012102466435

(51) Int. Cl. G07F 9/10; G07F 11/42

(52) U.S. Cl. CPC G07F 9/10; G07F 11/42
USPC 221/258; 221/282

(57) ABSTRACT

A product receiving structure is located in a vending machine and includes a cabinet. The cabinet includes a bottom plate and a plurality of shelves located on the bottom plate. Each adjacent two of the plurality of shelves are configured for receiving a plurality of products. A plurality of strengthening pieces is located on the bottom plate and arranged in a substantially wave shaped for strengthening the bottom plate. Each of the plurality of strengthening pieces extends in a direction substantially perpendicular to the plurality of shelves.

### BACKGROUND

1. Technical Field

The present disclosure relates to a vending machine for selling a canned product, a glass product, a plastic-bottled product, for example, more particularly to a vending machine with a product receiving structure.

2. Description of Related Art

A vending machine is used everywhere for providing twenty-four hour service. In the vending machine, a cabinet is provided with a plurality of shelves. The plurality of shelves is secured to a bottom plate of the cabinet and supports many products, which are very heavy. In order to prevent the bottom plate from being deformed, a plurality of supporting structures, such as posts, is provided to support the plurality of shelves. However, the plurality of supporting structures may increase cost of the vending machine.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of product receiving structure in accordance with an embodiment.

FIG. 2 is an enlarged view of a circled portion II of FIG. 1.

FIG. 3 is an isometric view of an assembly of the product receiving structure of FIG. 1.

FIG. 4 is an isometric view of a bottom plate of the product receiving structure of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

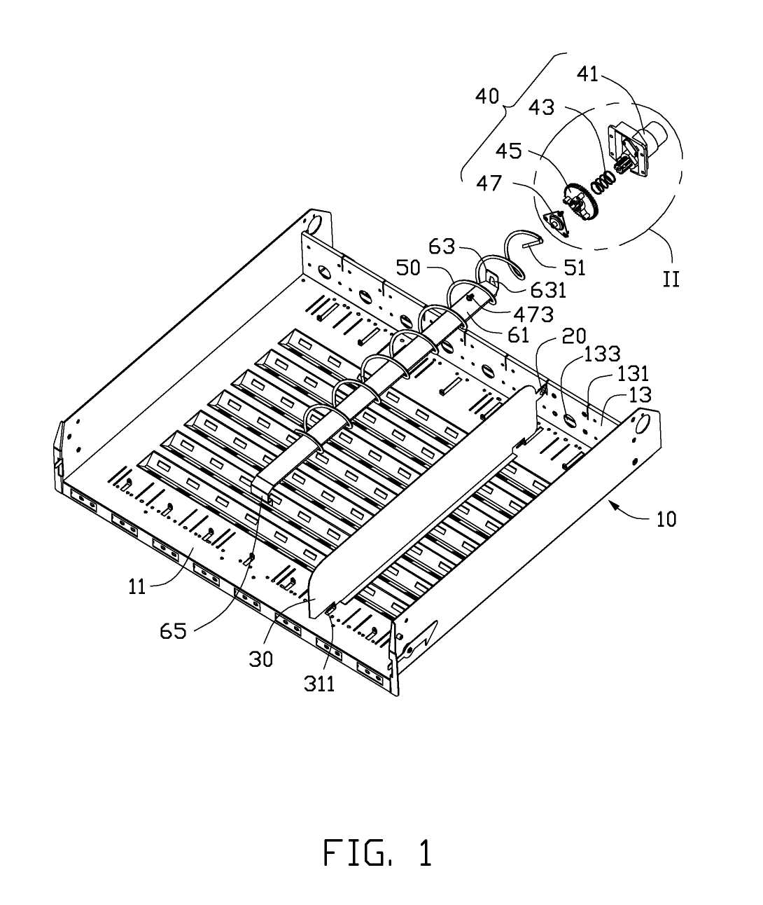

FIGS. 1-4 illustrate a product receiving structure of an embodiment located in a vending machine, which is used for selling a canned product, or a plastic-bottled product, like a beverage such as water, for example.

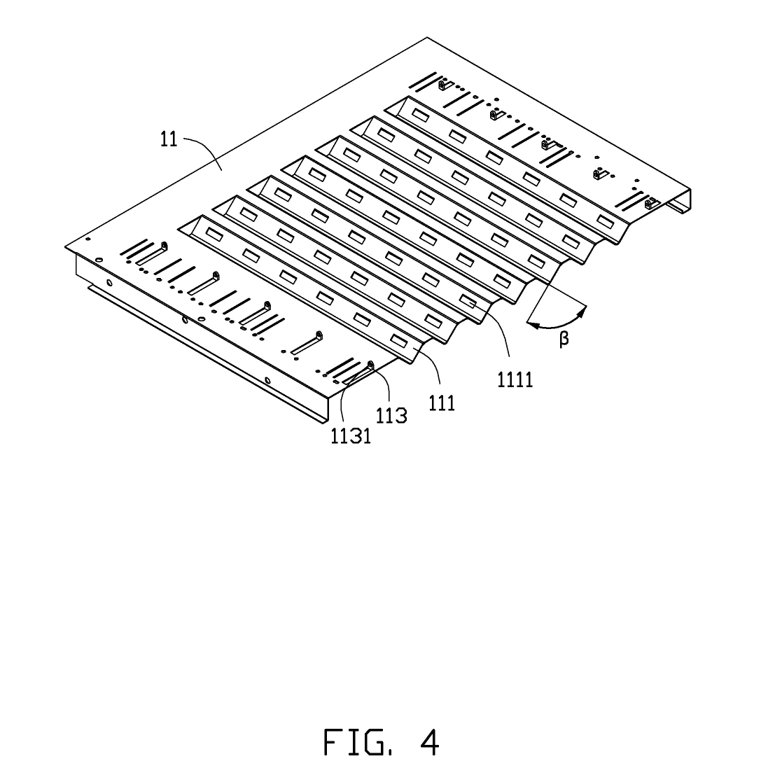

The product receiving structure comprises a cabinet 10. The cabinet 10 comprises a bottom plate 11 and a plurality of shelves 30 located on the bottom plate 11. Each adjacent two of the plurality of shelves 30 is configured for receiving a plurality of products 80 (only one shown in FIG. 4). A plurality of strengthening pieces 111 located on or extending from the bottom plate 11 and arranged in a substantially wave shaped, for strengthening structure of the bottom plate 11. Each of the plurality of strengthening pieces 111 extends in a direction substantially perpendicular to the plurality of shelves 30.

An acute angle β is defined between each two adjacent of the plurality of shelves 30. Each of the plurality of strengthening pieces 111 defines a plurality of ventilation holes 1111, for dissipating heat out of the cabinet 10.

The plurality of shelves 30 is pivotably secured to the bottom plate 11. In the illustrated embodiment, a plurality of pivot tabs 113, each with a pivot hole 1131 (shown in FIG. 4), extends from the bottom plate 11, and a pivot pin 311 extends from each of the plurality of shelves 30 and is engaged in the pivot hole 1131 of each of the plurality of pivot tabs 113.

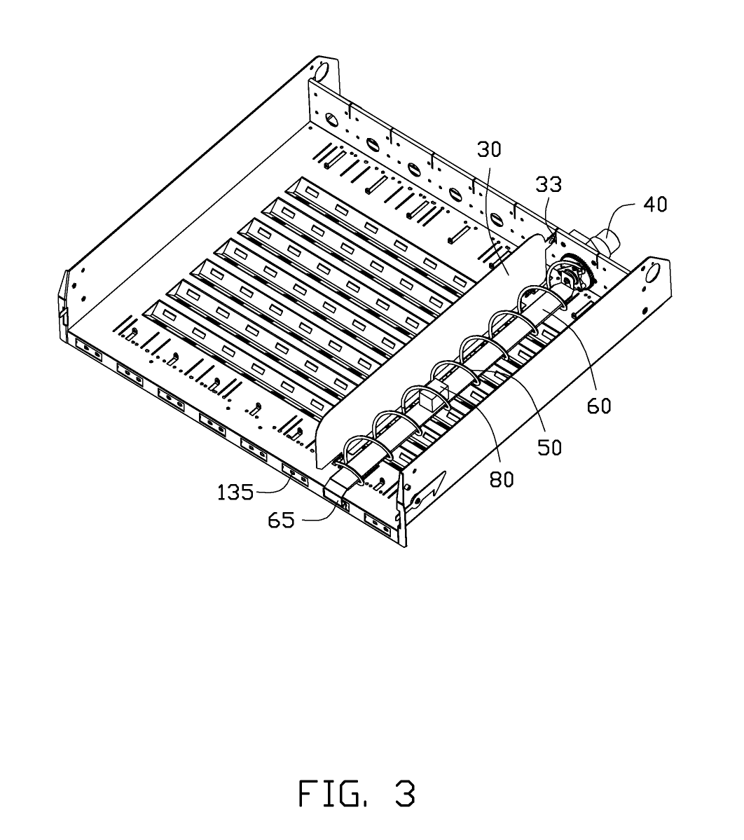

The cabinet further comprises a rear plate 13, which defines a plurality of slots 131, and a mounting piece 33 (shown in FIG. 3) is pivotably secured to each of the plurality of shelves 30 and is received in each of the plurality of slots 131. The mounting piece 33 is rotatable out of each of the plurality of slots 131 when each of the plurality of shelves 30 is removed from the cabinet 10. In the illustrated embodiment, each mounting piece 33 is pivotably secured to each of the plurality of shelves 30 with a first fastener 20 (shown in FIG. 1), such as a screw, or a rivet. In an embodiment, the plurality of shelves 30 is substantially perpendicular to the bottom plate 11 and the rear plate 13.

The product receiving structure further comprises a plurality of drive mechanisms 40, a plurality of guides 60, and a plurality of slave members 50. In the following, only one drive mechanism 40, one guide 60, and one slave member 50 are described as an example. The drive mechanism 40 is secured to the rear plate 13. The guide 60 is secured to the bottom plate 11 and the drive mechanism 40 for supporting the plurality of products 80. The slave member 50 is secured to the drive mechanism 40 and surrounds the guide 60. The slave member 50 is rotatable by the drive mechanism 40 for pushing the plurality of products 80 along the guide 60. In an embodiment, the slave member 50 is spiral shape.

The drive mechanism 40 comprises a motor 41 with a rotating shaft 411. The rotating shaft 411 defines a locking hole 413, and an end of the slave member 50 is engaged in the locking hole 413.

The drive mechanism 40 further comprises a plurality of gears 45 and a plurality of resilient members 43. In the following, only one gear 45 and one resilient member 43 are described as an example. The gear 45 meshes with the rotating shaft 411 of the motor 41 and is rotated by the rotating shaft 411 when the motor 41 runs. In the illustrated embodiment, the gear 45 comprises a connecting portion 453 with a securing hole 4531, a plurality of first teeth extends from the connecting portion 453 in the securing hole 4531, and a plurality of second teeth extends from the rotating shaft 411 meshing with the first teeth. The motor 41 is located outside of the rear plate 13, the gear 45 is located inside of the rear plate 13, and the resilient member 43 is located between the motor 41 and the gear 45 and deformed to press the gear 45 away from the rear plate 13. In the illustrated embodiment, the rear plate 13 defines a through hole 133, the rotating shaft 411 and the resilient member 43 are inserted through the through hole 133, and the resilient member 43 surrounds the rotating shaft 411. In an embodiment, the resilient member 43 is a compression spring.

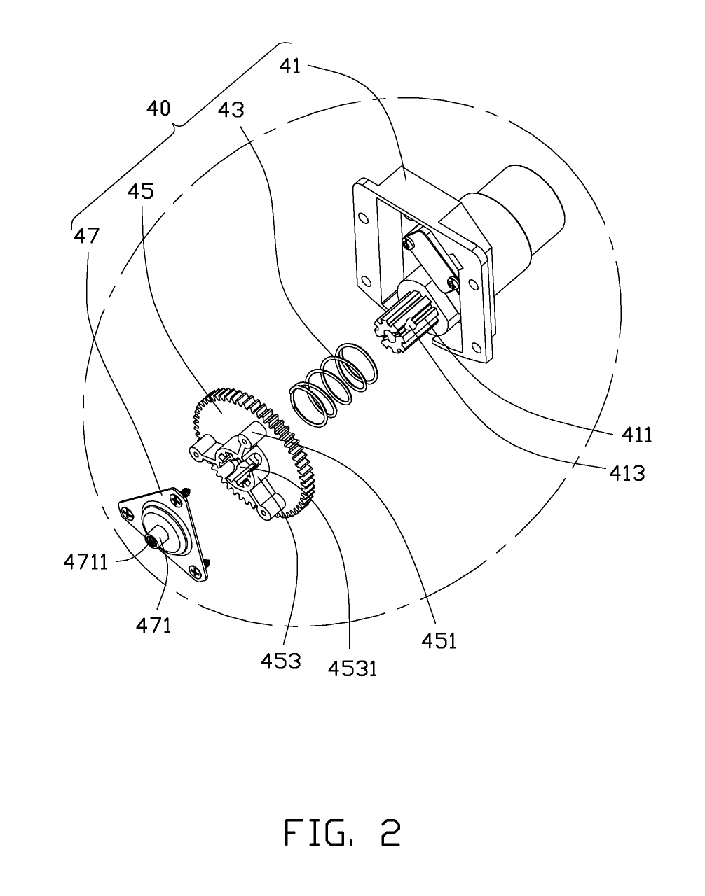

The drive mechanism 40 further comprises a plurality of mounting plates 47. In the following, only one mounting plate 47 is described as an example. The mounting plate 47 is secured to the gear 45. In the illustrated embodiment, the gear 45 further comprises three fixing posts 451 around the connecting portion 453. In addition, a fixing hole is defined in each of the three fixing posts 451, and three second fasteners, such as screws secured to the mounting plate 47 are engaged in the fixing holes of the three fixing posts 451, to secure the mounting plate 47 from the gear 45. The mounting plate 47 comprises a mounting post 471 with a mounting hole 4711 (shown in FIG. 2), and a third fastener 473 (shown in FIG. 1), such as a screw, is secured in the mounting hole 4711 and secure the end of the slave member 50 to the mounting plate 47.

FIGS. 1 and 3 shows that the guide 60 comprises a body 61 for supporting the plurality of products 80, a first locking piece 63, and a second locking piece 65. The first locking piece 63 and the second locking piece 65 extend from opposite ends of the body 61. The first locking piece 63 defines an installation hole 631, and the mounting post 471 is inserted through the installation hole 631. Two fastening tabs (not shown) extend from the second locking piece 65 and are engaged in two fastening holes 135 defined in the bottom plate 11.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A product receiving structure located in a vending machine, the product receiving structure comprising:
a cabinet comprising a bottom plate and a plurality of shelves located on the bottom plate, every two adjacent shelves configured for receiving a plurality of products, a plurality of strengthening pieces located on the bottom plate and arranged in substantially wave shape for strengthening the bottom plate, and each of the plurality of strengthening pieces extending in a direction substantially perpendicular to the plurality of shelves.

2. The product receiving structure of claim 1, wherein an acute angle is defined between each two adjacent of the plurality of shelves.

3. The product receiving structure of claim 1, wherein each of the plurality of strengthening pieces defines a plurality ventilation holes.

4. The product receiving structure of claim 1, wherein the plurality of shelves is pivotably secured to the bottom plate.

5. The product receiving structure of claim 4, wherein a plurality of pivot tabs, each with a pivot hole, extends from the bottom plate, and a pivot pin extends from each of the plurality of shelves and is engaged in the pivot hole of each of the plurality of pivot tabs.

6. The product receiving structure of claim 1, wherein the cabinet further comprises a rear plate, the rear plate defines a plurality of slots, and a mounting piece is pivotably secured to each of the plurality of shelves and is received in each of the plurality of slots.

7. The product receiving structure of claim 1, further comprising a driving mechanism secured to the bottom plate, a guide secured to the bottom plate and the driving mechanism for supporting the plurality of products, and a slave member secured to the driving mechanism and surrounding the guide; wherein the slave member is rotatable by the driving mechanism for pushing the plurality of products to move along the guide.

8. The product receiving structure of claim 7, wherein the driving mechanism comprises a motor with a rotating shaft, the rotating shaft defining a locking hole, and the slave member is engaged in the locking hole.

9. The product receiving structure of claim 8, wherein the driving mechanism further comprises a gear and a resilient member, the gear meshes with the rotating shaft of the motor, the motor is located outside of the rear plate, the gear is located inside of the rear plate, and the resilient member is located between the motor and the gear and is deformed to press the gear away from the rear plate.

10. The product receiving structure of claim 6, wherein the plurality of shelves is substantially perpendicular to the bottom plate and the rear plate.

11. A product receiving structure located in a vending machine, the product receiving structure comprising:
a cabinet comprising a bottom plate, a rear plate located on the bottom plate, and a plurality of shelves located on the bottom plate and the rear plate, each adjacent two of the plurality of shelves configured for receiving a plurality of products therebetween, a plurality of strengthening pieces located on the bottom plate and arranged in a substantially wave shaped for strengthening the bottom plate, and each of the plurality of strengthening pieces extending in a direction substantially perpendicular to the rear plate.

12. The product receiving structure of claim 11, wherein an acute angle is defined between each two adjacent of the plurality of shelves.

13. The product receiving structure of claim 11, wherein each of the plurality of strengthening pieces defines a plurality ventilation holes.

14. The product receiving structure of claim 11, wherein the plurality of shelves is pivotably secured to the bottom plate.

15. The product receiving structure of claim 14, wherein a plurality of pivot tabs, each with a pivot hole, extends from the bottom plate, and a pivot pin extends from each of the plurality of shelves and is engaged in the pivot hole of each of the plurality of pivot tabs.

16. The product receiving structure of claim 11, wherein the rear plate defines a plurality of slots, and a mounting piece is pivotably secured to each of the plurality of shelves and is received in each of the plurality of slots.

17. The product receiving structure of claim 11, wherein the plurality of shelves is substantially perpendicular to the bottom plate.

18. A vending machine comprising:
a product receiving structure comprising a cabinet, the cabinet comprising a bottom plate and a plurality of shelves located on the bottom plate, each adjacent two of the plurality of shelves configured for receiving a plurality of products therebetween; a plurality of strengthening pieces located on the bottom plate and arranged in a substantially wave shaped for strengthening the bottom plate, and each of the plurality of strengthening pieces extending in a direction substantially perpendicular to the plurality of shelves.

19. The vending machine of claim 18, wherein a plurality of pivot tabs, each with a pivot hole, extends from the bottom plate, and a pivot pin extends from each of the plurality of shelves and is engaged in the pivot hole of each of the plurality of pivot tabs.

20. The vending machine of claim 18, wherein the cabinet further comprises a rear plate, the rear plate defines a plurality of slots, and a mounting piece is pivotably secured to each of the plurality of shelves and is received in each of the plurality of slots.
